(19) United States
(12) Patent Application Publication
(10) Pub. No.: US 2016/0241048 A1
(43) Pub. Date: Aug. 18, 2016

(54) Battery Assembly Combining Multiple Different Batteries

(71) Applicant: Microsoft Technology Licensing, LLC, Redmond, WA (US)

(72) Inventors: Anirudh Badam, Redmond, WA (US); Ranveer Chandra, Bellevue, WA (US); Julia L. Meinershagen, Seattle, WA (US); Nissanka Arachchige Bodhi Priyantha, Redmond, WA (US); Stephen E. Hodges, Cambridge (GB); Thomas Moscibroda, Beijing (CN)

(21) Appl. No.: 14/624,825

(22) Filed: Feb. 18, 2015

(51) Int. Cl. H02J 7/00

(52) U.S. Cl. CPC H02J 7/0003; H02J 7/0024

(57) ABSTRACT

Techniques for battery assembly combining multiple different batteries are described herein. Generally, an example battery assembly includes multiple individual batteries of differing sizes and capacities. In at least some embodiments, the individual batteries are connected to a battery interface that presents the multiple batteries as a single integrated power source.

### BACKGROUND

Many devices today utilize some form of battery for various power needs, such as a primary power source, a backup power source, and so forth. Battery placement is a primary concern, especially in mobile devices where space and weight conservation are at the forefront. Current device designs typically require a large single space to be set aside within a device to accommodate a battery.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Techniques for battery assembly combining multiple different batteries are described herein. Generally, an example battery assembly includes multiple individual batteries of differing sizes and capacities. In at least some embodiments, the individual batteries are connected to a battery interface that presents the multiple batteries as a single integrated power source.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation that is operable to employ techniques discussed herein in accordance with one or more embodiments.

FIG. 2 illustrates an example battery assembly in accordance with one or more embodiments.

FIG. 3 depicts a circuit diagram of an example battery assembly in accordance with one or more embodiments.

FIG. 4 is a flow diagram that describes steps in a method for adjusting load on a battery in accordance with one or more embodiments.

FIG. 5 is a flow diagram that describes steps in a method for adjusting a battery charge rate in accordance with one or more embodiments.

FIG. 6 is a flow diagram that describes steps in a method for presenting status information for a battery assembly in accordance with one or more embodiments.

FIG. 7 illustrates an example system and computing device as described with reference to FIG. 1, which are configured to implement embodiments of techniques described herein.

### DETAILED DESCRIPTION

Overview

Techniques for battery assembly combining multiple different batteries are described herein. Generally, an example battery assembly includes multiple individual batteries of differing sizes and capacities. In at least some implementations, the individual batteries are connected to a battery interface that presents the multiple batteries as a single integrated power source.

According to one or more implementations, a battery assembly is configured such that individual batteries of the battery assembly have a common discharge rate and/or charge rate. For instance, resistors of different resistances are utilized to control discharge rate and/or charge rate of the individual batteries such that the individual batteries are discharged and/or charged at a rate that is relative to their respective total charge capacities. Implementations further include a graphical user interface (GUI) that represents the battery assembly as a single integrated battery, and that displays state information for the battery assembly as though the battery assembly is a single battery.

In the following discussion, an example environment is first described that is operable to employ techniques described herein. Next, a section entitled “Example Battery Assembly” describes attributes of an example battery assembly in accordance with one or more implementations. Following this, a section entitled “Example Procedures” describes some example procedures for a battery assembly combining multiple different batteries in accordance with one or more embodiments. Finally, a section entitled “Example System and Device” describes an example system and device that are operable to employ techniques discussed herein in accordance with one or more embodiments.

Example Environment

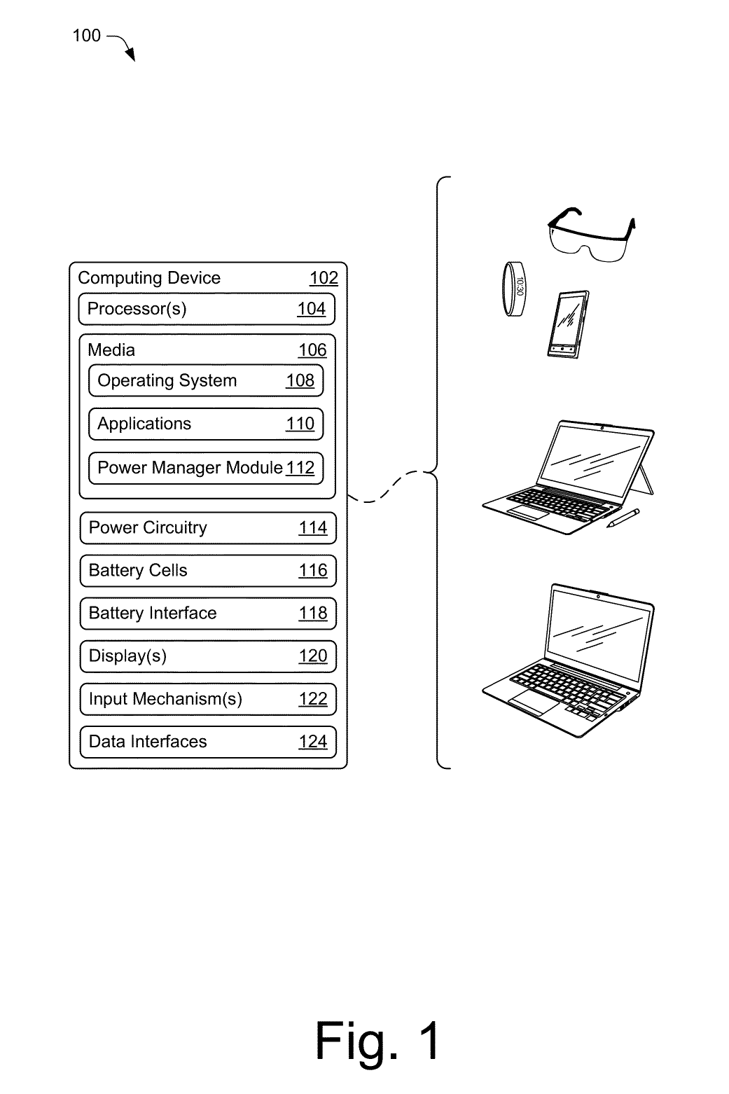

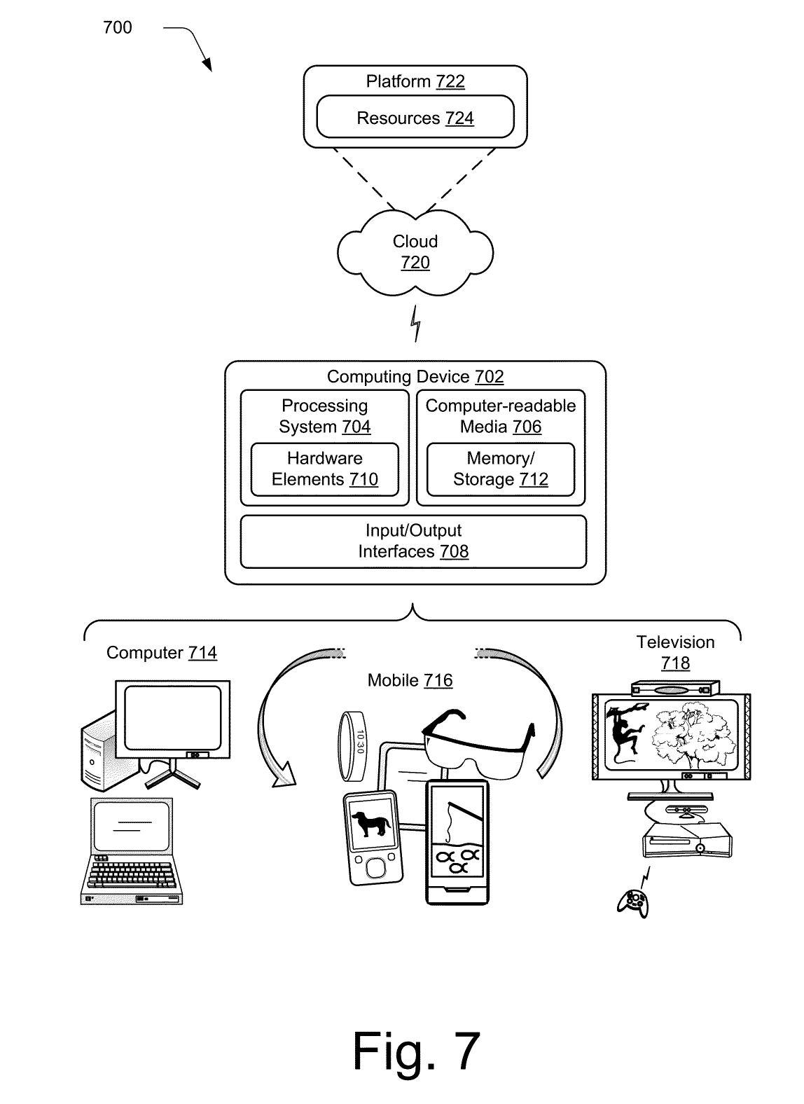

FIG. 1 illustrates an example environment 100 for performing techniques for battery assembly combining multiple different batteries. Environment 100 includes a computing device 102, which may be implemented in various ways. The computing device 102, for instance, may be configured as a traditional computer (e.g., a desktop personal computer, laptop computer, and so on), a mobile station, an entertainment appliance, a wireless phone, a tablet, a netbook, a wearable device, and so forth as further described in relation to FIG. 7.

Thus, the computing device 102 may range from full resource devices with substantial memory and processor resources (e.g., personal computers, game consoles) to a low-resource device with limited memory and/or processing resources, such as a traditional set-top box, a hand-held game console, a wearable device, a smart appliance (e.g., an “Internet of Things” (IoT) device), a health monitoring and assistance device, a personal navigation device, and so forth. The computing device 102 also relates to software that causes the computing device 102 to perform various operations.

Further, while implementations are discussed herein with reference to a computing device, it is to be appreciated that techniques discussed herein may be utilized in any apparatus that utilizes batteries, such as a medical device, a vehicle (e.g., an electronic vehicle), a robotic machine, a toy, and so forth. The computing device 102, for instance, may be implemented as a controller for such an apparatus.

Computing device 102 includes computer processor(s) 104 and computer-readable storage media 106 (media 106). Media 106 includes an operating system 108, applications 110, and a power manager module (hereinafter “power manager”) 112.

Computing device 102 also power circuitry 114, battery cells 116 from which computing device 102 can draw power to operate, and a battery interface 118. Generally, the power circuitry 114 may include firmware or hardware configured to enable computing device 102 to draw operating power from the battery cells 116 and to apply charging power to the battery cells 116. The battery cells 116 may include any suitable number or type of rechargeable battery cells, such as lithium-ion (Lion), lithium-polymer (Li-Poly), lithium ceramic (Li-C), flexible printed circuit (FPC) Li-C, and the like.

The battery interface 118 is representative of functionality to enable power connectivity of the battery cells 116. As further detailed below, the battery cells 116 are electrically connected to the battery interface 118 such that the battery cells 116 are represented to components of the computing device 102 as a single integrated battery. Implementations and uses of power circuitry 114, battery cells 116, and the battery interface 118 vary and are described in greater detail below.

The power manager 112 is representative of functionality to enable various operational parameters of the battery cells 116 to be monitored, controlled, and exposed. For instance, the power manager 112 may interface with the power circuitry 114, the battery interface 118, and/or directly with the battery cells 116 to configure and reconfigure operational parameters of the dynamic battery 116.

Computing device 102 also includes one or more displays 120, input mechanisms 122, and data interfaces 124. The displays 120 are generally representative of hardware and logic for visual output. The input mechanisms 122 may include gesture-sensitive sensors and devices, such as touch-based sensors and movement-tracking sensors (e.g., camera-based), as well as mice (free-standing or integral with a keyboard), a stylus, touch pads, accelerometers, and microphones with accompanying voice recognition software, to name a few. The input mechanisms 122 may be separate or integral with displays 120, with integral examples including gesture-sensitive displays with integrated touch-sensitive or motion-sensitive sensors.

The data interfaces 124 include any suitable wired or wireless data interfaces that enable computing device 102 to communicate data with other devices or networks. Wired data interfaces may include serial or parallel communication interfaces, such as a universal serial bus (USB) and local-area-network (LAN). Wireless data interfaces may include transceivers or modules configured to communicate via infrastructure or peer-to-peer networks. One or more of these wireless data interfaces may be configured to communicate via near-field communication (NFC), a personal-area-network (PAN), a wireless local-area-network (WLAN), or wireless wide-area-network (WWAN). In at least some implementations, the operating system 108 or a communication manager (not shown) of computing device 102 selects a data interface for communications based on characteristics of an environment in which computing device 102 operates.

The operating system 108 manages resources of computing device 102 and may be implemented using any suitable instruction format. For instance, the operating system 108 generally enables functionalities of computing device 102 to access hardware and logic resources of computing device 102. Although the power manager 112 is illustrated separately from the operating system 108, it is to be appreciated that in at least some implementations, functionality of the power manager 112 may be implemented as part of the operating system 108.

The applications 110 include any suitable type of application and/or service, such as productivity applications, web browsers, media viewers, navigation applications, multimedia editing applications, and so forth. According to various implementations, the applications 110 may be implemented as locally-installed code that is executed as part of a local runtime environment. Additionally or alternatively, the applications 110 represent portals to distributed functionality, such as web services, cloud services, distributed enterprise services, and so forth.

Having discussed an example environment in which techniques for battery assembly combining multiple different batteries may be employed, consider now an example battery assembly in accordance with one or more implementations.

Example Battery Assembly

This section describes attributes of an example battery assembly in accordance with one or more implementations. The example battery assembly, for instance, represents an example implementation of the battery cells 116.

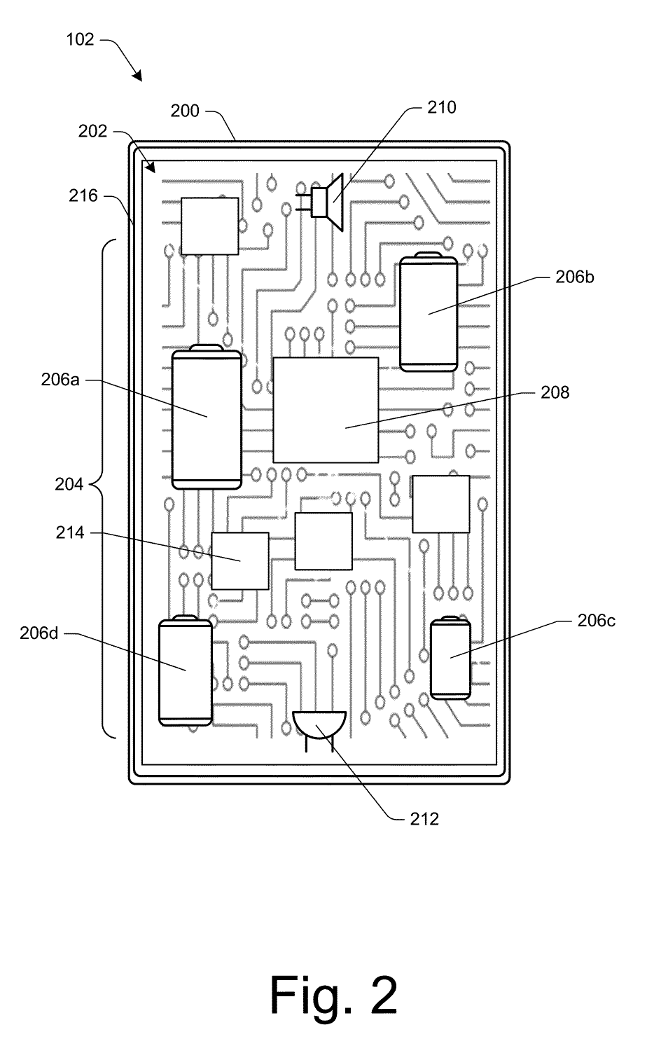

FIG. 2 illustrates a chassis 200 of the computing device 102 with an internal cavity 202 in which various internal components of the computing device 102 are attached and/or positioned. FIG. 2, for instance, depicts the computing device 102 with an outer portion (e.g., a cover) removed such that internal components of the computing device 102 are visible. Positioned in the internal cavity 202 is a battery assembly 204 in accordance with one or more implementations. Generally, the battery assembly includes batteries 206a, 206b, 206c, and 206d, which represent instances of the battery cells 116. Notice that the batteries 206a-206d are of differing sizes and differing physical dimensions. While the battery assembly 204 is illustrated with four batteries, it is to be appreciated that other battery configurations may be employed that utilize more or less than four batteries in accordance with implementations discussed herein.

Further illustrated are other internal components of the computing device 102, including a central processing unit 208, a speaker 210, a microphone 212, and a memory 214. These components are presented for purpose of example only, and is to be appreciated that the computing device 102 includes a variety of other components not expressly illustrated and enumerated herein.

As illustrated, the batteries 206a-206d of the battery configuration 204 are distributed in voids throughout the internal cavity 200. Further, at least some of the batteries are separated from one another by one or more internal components that are not batteries. For instance, one or more of the batteries 206a-206d are placed in voids between internal components of the computing device 102, and/or voids between an internal component of the computing device 102 and a peripheral edge 216 of the chassis 200. Thus, the battery assembly 204 enables efficient use of space within the internal cavity 200 by leveraging empty spaces surrounding various components for battery placement.

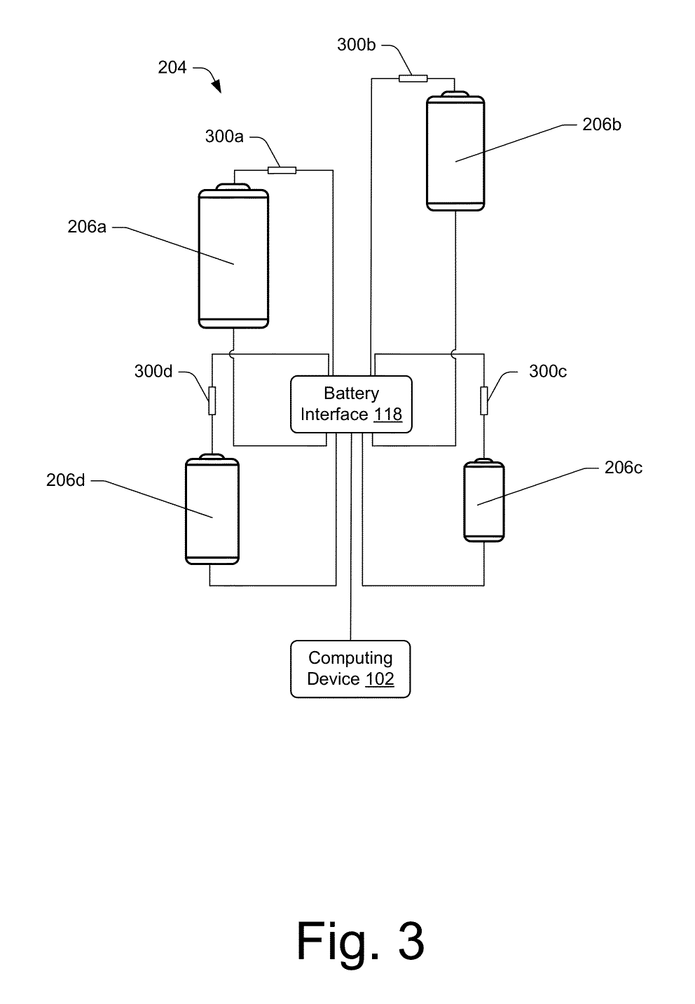

FIG. 3 depicts a circuit diagram of the battery assembly 204 in accordance with one or more implementations. For ease of viewing, the battery assembly 204 is illustrated without other portions of the computing device 102.

The battery assembly 204 includes the batteries 206a-206d electrically connected to the battery interface 118, and further includes metal-oxide-semiconductor field-effect transistors (MOSFETs) 300a, 300b, 300c, and 300d connected between positive terminals of the respective batteries 206a-206d and the battery interface 118. While implementations are discussed herein as utilizing MOSFETs, it is to be appreciated that any suitable resistance device (e.g., resistor) may be employed.

According to various implementations, one or more of the batteries 206a-206d have differing capacities and differing physical sizes. For instance, the battery 206a has a larger capacity than the battery 206d. Accordingly, in at least some implementations the MOSFETs 300a-300d are selected with a resistance such that a discharge rate (C-rate) for each of the batteries 206a-206d is approximately (e.g., +/−5%) equal. Further, in at least some implementations, the MOSFETs 300a-300d enable a charge rate for the batteries 206a-206d to be approximately (e.g., +/−5%) equal. For instance, the MOSFETs 300a-300d each have a resistance that is inversely proportional to the capacities of their respective batteries. The MOSFET 300d, for example, has a higher resistance than the MOSFET 300a such that the discharge rate of the battery 206d is approximately equal to the discharge rate of the battery 206a, and such that the charge rate of the battery 206d is approximately equal to the charge rate of the battery 206a. As discussed herein, discharge rate is a measure of a rate at which a battery is discharged relative to its maximum capacity, e.g., its C-rate. Further, charge rate refers to a rate at which a battery is charged relative to its maximum capacity, and may also be referred to as a battery's C-rate. In at least some implementations, techniques discussed herein enable the time to discharge each of the batteries 206a-206d to be configured such that the batteries 206a-206d discharge at approximately the same discharge rate, and further enable the time to charge each of the batteries 206a-206d to be configured such that the batteries 206a-206d charge at approximately the same charge rate.

According to various implementations, the battery interface 118 receives current from the batteries 206a-206d, combines the current, and presents the current as a single power source to the computing device 102. Thus, in at least some implementations other components of the computing device 102 do not receive power from and/or interact directly with the individual batteries 206a-206d, but receive current from the batteries 206a-206d via the battery interface 118. Thus, the batteries 206a-206d are represented in the computing device 102 as a single power source, e.g., a single battery.

As further illustrated, the batteries 206a-206d are not directly connected to one another (e.g., in series or parallel), but are connected to the battery interface 118. Thus, the battery interface 118 presents power from the batteries 206a-206d as a single power source, and distributes charging power individually to the different batteries 206a-206d.

According to various implementations, the battery interface 118 includes current adjustment functionality (e.g., a potentiometer or rheostat) that is configured to individually adjust power draw from and charging power to the individual batteries 206a-206d. For instance, the power levels of the individual batteries 206a-206d is monitored, and discharge current and/or charge current of the individual batteries 206a-206d is adjusted based on their charge level, e.g., remaining charge. In at least some implementations, the discharge current (e.g., applied load) is adjusted such to maintain the individual batteries 206a-206d at a common discharge rate. Further, a charging current for the individual batteries 206a-206d is individually adjustable to maintain a common charging rate. For instance, the batteries 206a-206d may have different individual discharging currents and/or charging currents to enable a consistent discharge rate and/or charge rate to be maintained across the batteries 206a-206d.

Having discussed an example battery assembly, consider now some example procedures in accordance with one or more implementations.

Example Procedures

This section describes some example procedures for a battery assembly combining multiple different batteries in accordance with one or more implementations. The procedures are shown as sets of operations (or acts) performed, such as through one or more entities or modules, and is not necessarily limited to the order shown for performing the operations. The example procedures may be employed in the environment 100 of FIG. 1, the system 700 of FIG. 7, and/or any other suitable environment. In at least some implementations, steps described for the procedures are implemented automatically and independent of user interaction.

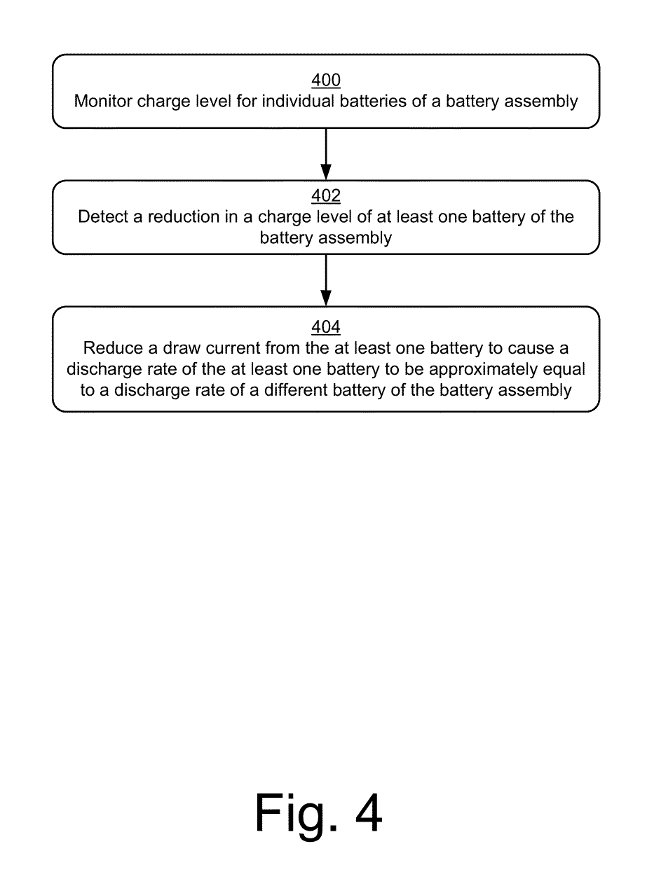

FIG. 4 is a flow diagram that describes steps in a method in accordance with one or more embodiments. The method, for instance, describes an example procedure for adjusting load on a battery in accordance with one or more embodiments.

Step 400 monitors charge level for individual batteries of a battery assembly. The power manager 112, for instance, monitors battery charge level (e.g., remaining battery capacity) of the individual batteries of the battery assembly 204.

Step 402 detects a reduction in a charge level of at least one battery of the battery assembly. The power manager 112, for instance, detects that charge level for one of the batteries 206a-206d has dropped below a threshold charge level, e.g., as specified in Amp-Hours (Ah).

Step 404 reduces a draw current from the at least one battery to cause a discharge rate of the at least one battery to be approximately equal to a discharge rate of a different battery of the battery assembly. The power manager 112, for instance, controls the battery interface 118 to reduce a load on the at least one battery. In at least some implementations, an approximately equal discharge rate refers to a discharge rate of +/−5% of a C-rate of a reference battery, e.g., the different battery of the battery assembly.

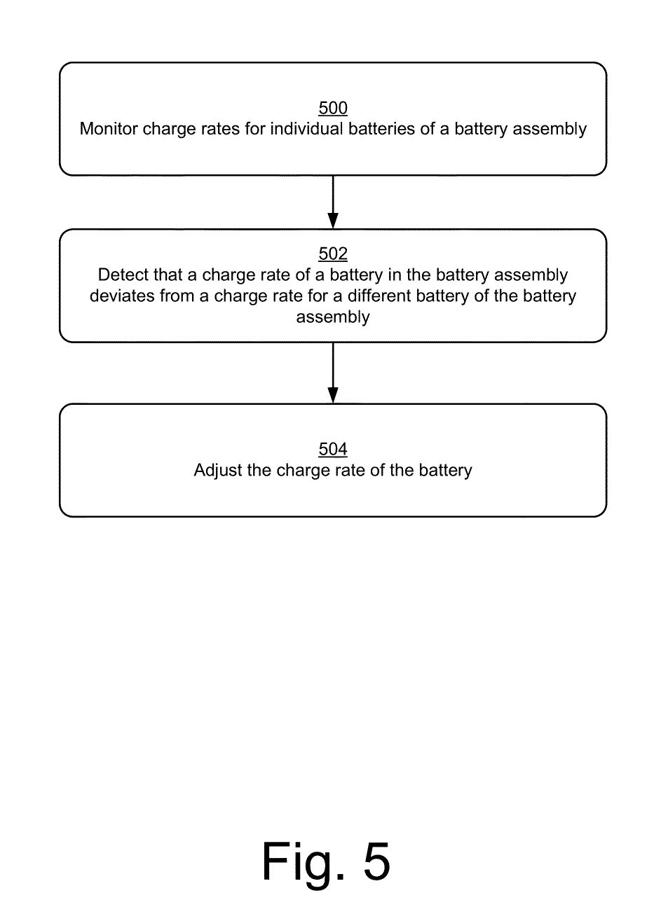

FIG. 5 is a flow diagram that describes steps in a method in accordance with one or more embodiments. The method, for instance, describes an example procedure for adjusting a charge rate of a battery in accordance with one or more implementations.

Step 500 monitors charge rates for individual batteries of a battery assembly. The power manager 112, for instance, monitors battery charge rate of the individual batteries of the battery assembly 204.

Step 502 detects that a charge rate of a battery in the battery assembly deviates from a charge rate for a different battery of the battery assembly. The power manager 112, for instance, detects that charge rate for one of the batteries 206a-206d has deviated a threshold amount from an average charge rate for the battery assembly 204. For example, the average charge rate is determined by averaging the charge rates for the individual batteries of the battery assembly 204.

Step 504 adjusts the charge rate of the battery. The power manager 112, for instance, controls the battery interface 118 to adjust (e.g., decrease or increase) a charge rate of the battery to bring the charge rate within a threshold charge rate deviation for the battery assembly 204. In at least some implementations, adjusting the charge rate enables the individual batteries of the battery assembly 204 to have individual charge rates that fall within a threshold difference of an average charge rate for the battery assembly 204. In at least some implementations, a threshold charge rate refers to a charge rate of +/−5% of an average charge rate (e.g., C-rate) for the battery assembly.

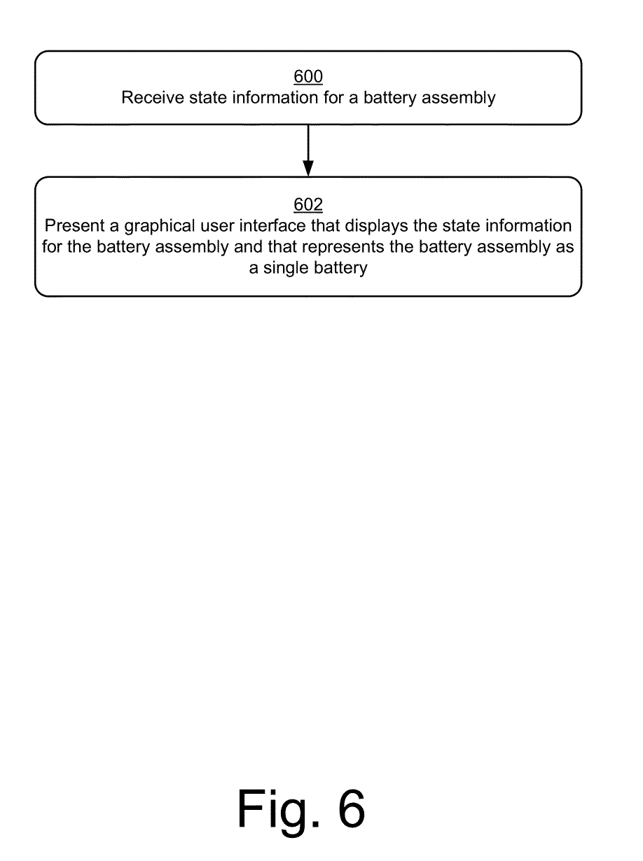

FIG. 6 is a flow diagram that describes steps in a method in accordance with one or more embodiments. The method, for instance, describes an example procedure for presenting status information for a battery assembly in accordance with one or more embodiments.

Step 600 receives state information for a battery assembly. The power manager 112, for instance, receives state information from the battery interface 118 for the battery assembly 204. Alternatively or additionally, the power manager 112 receives state information from the battery interface 118 for the individual batteries 206a-206d. Examples of battery state information include remaining charge level (e.g., remaining battery capacity), a load being drawn from the battery assembly, a rate at which the battery assembly is charging, a power management plan being enforced for the battery assembly, and so forth.

Step 602 presents a graphical user interface that displays the state information for the battery assembly and that represents the battery assembly as a single battery. For example, the power manager 112 causes a GUI to be displayed that visually represents the battery assembly as a single power source, e.g., a single battery.

In at least some implementations, the example procedures may be performed by the power manager 112, the battery interface 118, and/or interaction between the power manager 112 and the battery interface 118.

Having discussed example procedures for battery assembly combining multiple different batteries, consider now a discussion of an example system and device for performing various aspects of techniques for battery assembly combining multiple different batteries in accordance with one or more implementations.

Example System and Device

FIG. 7 illustrates an example system generally at 700 that includes an example computing device 702 that is representative of one or more computing systems and/or devices that may implement various techniques described herein. For example, the computing device 102 discussed above with reference to FIG. 1 can be embodied as the computing device 702. The computing device 702 may be, for example, a server of a service provider, a device associated with the client (e.g., a client device), an on-chip system, and/or any other suitable computing device or computing system.

The example computing device 702 as illustrated includes a processing system 704, one or more computer-readable media 706, and one or more Input/Output (I/O) Interfaces 708 that are communicatively coupled, one to another. Although not shown, the computing device 702 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 704 is representative of functionality to perform one or more operations using hardware. Accordingly, the processing system 704 is illustrated as including hardware element 710 that may be configured as processors, functional blocks, and so forth. This may include implementation in hardware as an application specific integrated circuit or other logic device formed using one or more semiconductors. The hardware elements 710 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable media 706 is illustrated as including memory/storage 712. The memory/storage 712 represents memory/storage capacity associated with one or more computer-readable media. The memory/storage 712 may include volatile media (such as random access memory (RAM)) and/or nonvolatile media (such as read only memory (ROM), Flash memory, optical disks, magnetic disks, and so forth). The memory/storage 712 may include fixed media (e.g., RAM, ROM, a fixed hard drive, and so on) as well as removable media (e.g., Flash memory, a removable hard drive, an optical disc, and so forth). The computer-readable media 706 may be configured in a variety of other ways as further described below.

Input/output interface(s) 708 are representative of functionality to allow a user to enter commands and information to computing device 702, and also allow information to be presented to the user and/or other components or devices using various input/output devices. Examples of input devices include a keyboard, a cursor control device (e.g., a mouse), a microphone (e.g., for voice recognition and/or spoken input), a scanner, touch functionality (e.g., capacitive or other sensors that are configured to detect physical touch), a camera (e.g., which may employ visible or non-visible wavelengths such as infrared frequencies to detect movement that does not involve touch as gestures), and so forth. Examples of output devices include a display device (e.g., a monitor or projector), speakers, a printer, a network card, tactile-response device, and so forth. Thus, the computing device 702 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” “entity,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 702. By way of example, and not limitation, computer-readable media may include “computer-readable storage media” and “computer-readable signal media.”

“Computer-readable storage media” may refer to media and/or devices that enable persistent storage of information in contrast to mere signal transmission, carrier waves, or signals per se. Computer-readable storage media do not include signals per se. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 702, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, radio frequency (RF), infrared, and other wireless media.

As previously described, hardware elements 710 and computer-readable media 706 are representative of instructions, modules, programmable device logic and/or fixed device logic implemented in a hardware form that may be employed in some embodiments to implement at least some aspects of the techniques described herein. Hardware elements may include components of an integrated circuit or on-chip system, an application-specific integrated circuit (ASIC), a field-programmable gate array (FPGA), a complex programmable logic device (CPLD), and other implementations in silicon or other hardware devices. In this context, a hardware element may operate as a processing device that performs program tasks defined by instructions, modules, and/or logic embodied by the hardware element as well as a hardware device utilized to store instructions for execution, e.g., the computer-readable storage media described previously.

Combinations of the foregoing may also be employed to implement various techniques and modules described herein. Accordingly, software, hardware, or program modules and other program modules may be implemented as one or more instructions and/or logic embodied on some form of computer-readable storage media and/or by one or more hardware elements 710. The computing device 702 may be configured to implement particular instructions and/or functions corresponding to the software and/or hardware modules. Accordingly, implementation of modules that are executable by the computing device 702 as software may be achieved at least partially in hardware, e.g., through use of computer-readable storage media and/or hardware elements 710 of the processing system. The instructions and/or functions may be executable/operable by one or more articles of manufacture (for example, one or more computing devices 702 and/or processing systems 704) to implement techniques, modules, and examples described herein.

As further illustrated in FIG. 7, the example system 700 enables ubiquitous environments for a seamless user experience when running applications on a personal computer (PC), a television device, and/or a mobile device. Services and applications run substantially similar in all three environments for a common user experience when transitioning from one device to the next while utilizing an application, playing a video game, watching a video, and so on.

In the example system 700, multiple devices are interconnected through a central computing device. The central computing device may be local to the multiple devices or may be located remotely from the multiple devices. In one embodiment, the central computing device may be a cloud of one or more server computers that are connected to the multiple devices through a network, the Internet, or other data communication link.

In one embodiment, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one embodiment, a class of target devices is created and experiences are tailored to the generic class of devices. A class of devices may be defined by physical features, types of usage, or other common characteristics of the devices.

In various implementations, the computing device 702 may assume a variety of different configurations, such as for computer 714, mobile 716, and television 718 uses. Each of these configurations includes devices that may have generally different constructs and capabilities, and thus the computing device 702 may be configured according to one or more of the different device classes. For instance, the computing device 702 may be implemented as the computer 714 class of a device that includes a personal computer, desktop computer, a multi-screen computer, laptop computer, netbook, and so on.

The computing device 702 may also be implemented as the mobile 716 class of device that includes mobile devices, such as a mobile phone, portable music player, portable gaming device, a tablet computer, a wearable device, a multi-screen computer, and so on. The computing device 702 may also be implemented as the television 718 class of device that includes devices having or connected to generally larger screens in casual viewing environments. These devices include televisions, set-top boxes, gaming consoles, and so on.

The techniques described herein may be supported by these various configurations of the computing device 702 and are not limited to the specific examples of the techniques described herein. For example, functionalities discussed with reference to the computing device 102 may be implemented all or in part through use of a distributed system, such as over a “cloud” 720 via a platform 722 as described below.

The cloud 720 includes and/or is representative of a platform 722 for resources 724. The platform 722 abstracts underlying functionality of hardware (e.g., servers) and software resources of the cloud 720. The resources 724 may include applications and/or data that can be utilized while computer processing is executed on servers that are remote from the computing device 702. Resources 724 can also include services provided over the Internet and/or through a subscriber network, such as a cellular or Wi-Fi network.

The platform 722 may abstract resources and functions to connect the computing device 702 with other computing devices. The platform 722 may also serve to abstract scaling of resources to provide a corresponding level of scale to encountered demand for the resources 724 that are implemented via the platform 722. Accordingly, in an interconnected device embodiment, implementation of functionality described herein may be distributed throughout the system 700. For example, the functionality may be implemented in part on the computing device 702 as well as via the platform 722 that abstracts the functionality of the cloud 720.

Discussed herein are a number of methods that may be implemented to perform techniques discussed herein. Aspects of the methods may be implemented in hardware, firmware, or software, or a combination thereof. The methods are shown as a set of steps that specify operations performed by one or more devices and are not necessarily limited to the orders shown for performing the operations by the respective blocks. Further, an operation shown with respect to a particular method may be combined and/or interchanged with an operation of a different method in accordance with one or more implementations. Aspects of the methods can be implemented via interaction between various entities discussed above with reference to the environment 100 and/or the system 700.

Implementations discussed herein include:

### Example 1

A mobile apparatus comprising: a chassis with an internal cavity that contains internal components of the mobile apparatus; a battery assembly that serves as a power source for the mobile apparatus and that includes multiple different batteries that are positioned in different voids throughout the internal cavity such that at least one of the batteries is physically separated from a different battery of the multiple different batteries by an internal component of the apparatus, the at least one battery having a different capacity than the different battery; and a battery interface to which the multiple different batteries are electrically connected, the battery interface combining the power output of the multiple different batteries such that the multiple different batteries are presented as a single power source.

### Example 2

A mobile apparatus as in example 1, wherein the at least one battery has different physical dimensions than the different battery.

### Example 3

A mobile apparatus as in one or more of examples 1 or 2, wherein the at least one battery has a smaller total capacity than the different battery.

### Example 4

A mobile apparatus as in one or more of examples 1-3, wherein the multiple different batteries are not directly connected to one another.

### Example 5

A mobile apparatus as in one or more of examples 1-4, wherein the battery interface is operable to perform operations including one or more of: reducing a draw current of the at least one battery to cause a discharge rate of the at least one battery to be approximately equal to a discharge rate of the different battery; or adjusting a charging rate of the at least one battery to cause a charge rate of the at least one battery to be approximately equal to a charge rate of the different battery.

### Example 6

A mobile apparatus as in one or more of examples 1-5, further comprising at least one resistance device electrically connected between the at least one battery and the battery interface to affect a discharge rate of the at least one battery such that the discharge rate of the at least one battery is approximately equal to a discharge rate of the different battery.

### Example 7

A mobile apparatus as in one or more of examples 1-6, wherein the internal component is not a battery.

### Example 8

A mobile apparatus as in one or more of examples 1-7, further comprising logic that is executable by a processing unit of the mobile apparatus to present a graphical user interface that displays state information for the battery assembly and that represents the battery assembly as a single power source.

### Example 9

A mobile apparatus as in one or more of examples 1-8, further comprising logic that is executable by a processing unit of the mobile apparatus to present a graphical user interface that displays status information for the battery assembly and that represents the battery assembly as a single battery.

### Example 10

A battery assembly comprising: multiple different batteries that are positioned in different voids throughout an internal cavity of a device such that at least one of the batteries is physically separated from a different battery of the multiple different batteries by an internal component of the apparatus, the at least one battery having a different capacity and different physical dimensions than the different battery; and a battery interface to which the multiple different batteries are electrically connected, the battery interface combining the power output of the multiple different batteries such that the multiple different batteries are presented to the device as a single power source.

### Example 11

A battery assembly as in example 10, further comprising at least one resistance device electrically connected between the at least one battery and the battery interface to affect a discharge rate of the at least one battery such that the discharge rate of the at least one battery is approximately equal to a discharge rate of the different battery.

### Example 12

A battery assembly as in one or more of examples 10 or 11, further comprising at least one resistance device electrically connected between the at least one battery and the battery interface to affect a charge rate of the at least one battery such that the charge rate of the at least one battery is approximately equal to a charge rate of the different battery.

### Example 13

A battery assembly as in one or more of examples 10-12, wherein the multiple different batteries are not directly connected to one another.

### Example 14

A battery assembly as in one or more of examples 10-13, wherein the internal component is not a battery.

### Example 15

A battery assembly as in one or more of examples 10-14, wherein the battery interface is operable to reduce a draw current of the at least one battery to further cause the discharge rate of the at least one battery to be approximately equal to the discharge rate of the different battery.

### Example 16

A battery assembly as in one or more of examples 10-15, further comprising at least one resistance device electrically connected between the at least one battery and the battery interface, and a different resistance device electrically connected between the different battery and the battery interface, the different resistance device having a lower resistance than the at least one resistance device.

### Example 17

A system comprising: a chassis with an internal cavity that contains internal components of the system; a battery assembly that serves as a power source for the system and that includes multiple different batteries that are positioned in different voids throughout the internal cavity such that at least one of the batteries is physically separated from a different battery of the multiple different batteries by an internal component of the system, the at least one battery having a different capacity than the different battery; one or more processors that are configured to receive power from the battery assembly; and one or more computer-readable storage media storing instructions that are executable by the one or more processors to perform operations including: detecting a reduction in a charge level of the at least one battery; and reducing a draw current from the at least one battery to cause a discharge rate of the at least one battery to be approximately equal to a discharge rate of the different battery.

### Example 18

A system as in example 17, further comprising a battery interface to which the multiple different batteries are electrically connected, wherein the battery interface is configured to combine current from the multiple different batteries such that the multiple different batteries are utilized by the system as a single integrated power source.

### Example 19

A system as in one or more of examples 17 or 18, wherein the operations further include: detecting that a charge rate of the at least one battery deviates from a charge rate for the different battery; and adjusting the charge rate of the battery in response to said detecting.

### Example 20

A system as in one or more of examples 17-19, wherein the operations further include presenting a graphical user interface that displays state information for the battery assembly and that represents the battery assembly as a single battery.

### CONCLUSION

Although embodiments of techniques and apparatuses battery assembly combining multiple different batteries have been described in language specific to features and/or methods, it is to be understood that the subject of the appended claims is not necessarily limited to the specific features or methods described. Rather, the specific features and methods are disclosed as example implementations battery assembly combining multiple different batteries.

What is claimed is:

1. A mobile apparatus comprising:
a chassis with an internal cavity that contains internal components of the mobile apparatus;
a battery assembly that serves as a power source for the mobile apparatus and that includes multiple different batteries that are positioned in different voids throughout the internal cavity such that at least one of the batteries is physically separated from a different battery of the multiple different batteries by an internal component of the apparatus, the at least one battery having a different capacity than the different battery; and
a battery interface to which the multiple different batteries are electrically connected, the battery interface combining the power output of the multiple different batteries such that the multiple different batteries are presented as a single power source.

2. A mobile apparatus as recited in claim 1, wherein the at least one battery has different physical dimensions than the different battery.

3. A mobile apparatus as recited in claim 1, wherein the at least one battery has a smaller total capacity than the different battery.

4. A mobile apparatus as recited in claim 1, wherein the multiple different batteries are not directly connected to one another.

5. A mobile apparatus as recited in claim 1, wherein the battery interface is operable to perform operations including one or more of:
reducing a draw current of the at least one battery to cause a discharge rate of the at least one battery to be approximately equal to a discharge rate of the different battery; or
adjusting a charging rate of the at least one battery to cause a charge rate of the at least one battery to be approximately equal to a charge rate of the different battery.

6. A mobile apparatus as recited in claim 1, further comprising at least one resistance device electrically connected between the at least one battery and the battery interface to affect a discharge rate of the at least one battery such that the discharge rate of the at least one battery is approximately equal to a discharge rate of the different battery.

7. A mobile apparatus as recited in claim 1, wherein the internal component is not a battery.

8. A mobile apparatus as recited in claim 1, further comprising logic that is executable by a processing unit of the mobile apparatus to present a graphical user interface that displays state information for the battery assembly and that represents the battery assembly as a single power source.

9. A mobile apparatus as recited in claim 1, further comprising logic that is executable by a processing unit of the mobile apparatus to present a graphical user interface that displays status information for the battery assembly and that represents the battery assembly as a single battery.

10. A battery assembly comprising:
multiple different batteries that are positioned in different voids throughout an internal cavity of a device such that at least one of the batteries is physically separated from a different battery of the multiple different batteries by an internal component of the apparatus, the at least one battery having a different capacity and different physical dimensions than the different battery; and
a battery interface to which the multiple different batteries are electrically connected, the battery interface combining the power output of the multiple different batteries such that the multiple different batteries are presented to the device as a single power source.

11. A battery assembly as recited in claim 10, further comprising at least one resistance device electrically connected between the at least one battery and the battery interface to affect a discharge rate of the at least one battery such that the discharge rate of the at least one battery is approximately equal to a discharge rate of the different battery.

12. A battery assembly as recited in claim 10, further comprising at least one resistance device electrically connected between the at least one battery and the battery interface to affect a charge rate of the at least one battery such that the charge rate of the at least one battery is approximately equal to a charge rate of the different battery.

13. A battery assembly as recited in claim 10, wherein the multiple different batteries are not directly connected to one another.

14. A battery assembly as recited in claim 10, wherein the internal component is not a battery.

15. A battery assembly as recited in claim 10, wherein the battery interface is operable to reduce a draw current of the at least one battery to further cause the discharge rate of the at least one battery to be approximately equal to the discharge rate of the different battery.

16. A battery assembly as recited in claim 10, further comprising at least one resistance device electrically connected between the at least one battery and the battery interface, and a different resistance device electrically connected between the different battery and the battery interface, the different resistance device having a lower resistance than the at least one resistance device.

17. A system comprising:
a chassis with an internal cavity that contains internal components of the system;
a battery assembly that serves as a power source for the system and that includes multiple different batteries that are positioned in different voids throughout the internal cavity such that at least one of the batteries is physically separated from a different battery of the multiple different batteries by an internal component of the system, the at least one battery having a different capacity than the different battery;
one or more processors that are configured to receive power from the battery assembly; and
one or more computer-readable storage media storing instructions that are executable by the one or more processors to perform operations including:
detecting a reduction in a charge level of the at least one battery; and
reducing a draw current from the at least one battery to cause a discharge rate of the at least one battery to be approximately equal to a discharge rate of the different battery.

18. The system as recited in claim 17, further comprising a battery interface to which the multiple different batteries are electrically connected, wherein the battery interface is configured to combine current from the multiple different batteries such that the multiple different batteries are utilized by the system as a single integrated power source.

19. The system as recited in claim 17, wherein the operations further include:
detecting that a charge rate of the at least one battery deviates from a charge rate for the different battery; and
adjusting the charge rate of the battery in response to said detecting.

20. The system as recited in claim 17, wherein the operations further include presenting a graphical user interface that displays state information for the battery assembly and that represents the battery assembly as a single battery.
